(19) United States
(12) Patent Application Publication
(10) Pub. No.: US 2005/0269792 A1
(43) Pub. Date: Dec. 8, 2005

(54) Dolly with drawer and method of use thereof

(76) Inventor: Jeff Aronson, McDonough, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/862,703

(22) Filed: Jun. 7, 2004

(51) Int. Cl. B62B 1/00

(52) U.S. Cl. 280/79.11

(57) ABSTRACT

A wheeled dolly with drawer and method of use thereof, wherein the dolly comprises a frame, wheels, and a drawer disposed under the frame. The frame supports a toolbox, thereby providing the ability to easily and safely move the toolbox.

### TECHNICAL FIELD

The present invention relates generally to wheeled dollies, and more specifically to a wheeled dolly with drawer and method of use thereof, wherein the dolly is adapted to support and transport a toolbox.

### BACKGROUND OF THE INVENTION

When utilizing a toolbox, it is often desirable to relocate its position, to a more convenient workplace. Since toolboxes are often heavy—typically of a weight suitable to strain a human frame if lifted-and safety dictates that some method other than physically carrying the toolbox be utilized to prevent undue physical damage to, and/or fatigue of, a user. However, most toolboxes have only a facility for carrying, such as a handle. Larger tool cabinets may incorporate wheels for occasionally moving same to new locations, but smaller toolboxes typically lack such a facility for mobility. Rolling drawer devices are shown by Handler et al (U.S. Pat. No. 4,597,122), Williams (U.S. Pat. No. 939,969), Spitzer et al. (U.S. Pat. No. 4,874,209) and Handler et al. (U.S. Design Patent No. 308,609). Burgess et al. (U.S. Pat. No. 5,873,643) shows a rolling cabinet having multiple drawers therein. The above devices, however, all lack the ability to hold or secure a toolbox thereon.

Additionally, when utilizing a toolbox, it is often necessary to extract several specific tools from a multitude of various sized tools, and place or position such tools in a convenient and accessible location for expeditious retrieval of same. Moreover, it is often necessary for more tool storage than is available in single compartment or dual-level toolboxes; thus, forcing users to separately tote “loose” tools in one hand, and carry an already full and fairly weighty toolbox in the other hand.

Therefore, it is readily apparent that there is a need for a device that can hold and/or secure a toolbox on a support framework, thus imparting rollability to the toolbox/dolly combination while contemporaneously providing separate storage via a drawer disposed below the supporting framework.

### BRIEF SUMMARY OF THE INVENTION

Briefly described, in a preferred embodiment, the present invention overcomes the above-mentioned disadvantages and meets the recognized need for such a device by providing a wheeled dolly with drawer and method of use thereof, wherein the dolly provides a means for transporting a toolbox from one location to another, and wherein the drawer provides additional storage for loose tools.

According to its major aspects and broadly stated, the present invention in its preferred form is a dolly with drawer and method of use thereof, comprising, in general, a frame, wheels, and drawer.

More specifically, the present invention is a wheeled dolly with drawer, wherein the dolly comprises of a frame of angle iron, wheels, and a drawer disposed under the frame. The frame is dimensioned and adapted to support a toolbox, thereby providing the ability to easily and safely move the toolbox to a selected location. The framework is generally rectangular in shape, wherein the ledges formed by the angle iron provide a perimeter that maintains the toolbox within the framework. The lower portion of the framework has a drawer and its supporting hardware, thereby providing added storage for loose tools. The framework may also include a plate that serves as a top to the drawer, wherein the drawer may have a lock included therewith, thereby collectively providing a securable space. The plate may further function as a work top and/or tool rest. A pin or bolt extends through the side of the framework and functions to restrain the drawer from continued forward movement after the drawer has been fully opened, thereby preventing the drawer from accidentally falling out of the framework.

Accordingly, a feature and advantage of the present invention is its ability to transport a toolbox.

Another feature and advantage of the present invention is its ability to provide added storage for loose tools.

Still another feature and advantage of the present invention is its ability to provide a lockable storage.

Yet another feature and advantage of the present invention is its ability to accommodate toolboxes of varying size.

Yet still another feature and advantage of the present invention is its ability to externally hold and/or support additional tools or other articles for ready use.

A further feature and advantage of the present invention is its ability to be utilized separately from the toolbox that it transports, wherein the toolbox may be removed, and the wheeled dolly with drawer can then be utilized as rolling storage and/or for moving other large objects.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a perspective view of a wheeled dolly with drawer according to a preferred embodiment of the present invention, shown carrying a toolbox with the drawer in closed position;

FIG. 1B is a perspective view of a wheeled dolly with drawer according to a preferred embodiment of the present invention, shown carrying a toolbox with the drawer in open position;

FIG. 2 is a perspective view of a wheeled dolly with drawer according to a preferred embodiment of the present invention;

FIG. 3A is a bottom perspective view of a wheeled dolly with drawer according to a preferred embodiment of the present invention;

FIG. 3B is a top perspective view of a wheeled dolly with drawer according to a preferred embodiment of the present invention; and

FIG. 4 is a perspective view of a wheeled dolly with drawer according to an alternate embodiment of the present invention.

### DETAILED DESCRIPTION OF THE PREFERRED AND SELECTED ALTERNATIVE EMBODIMENTS

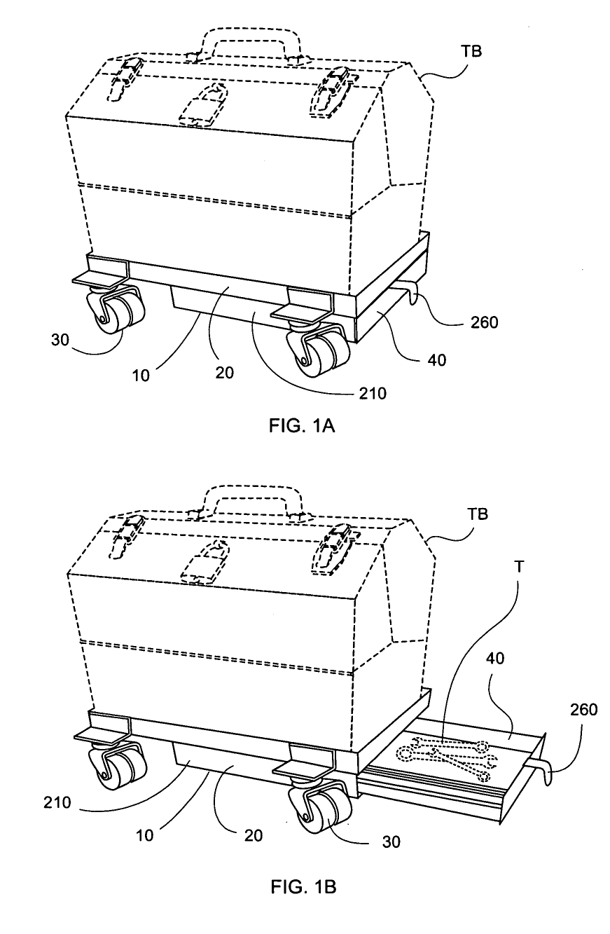

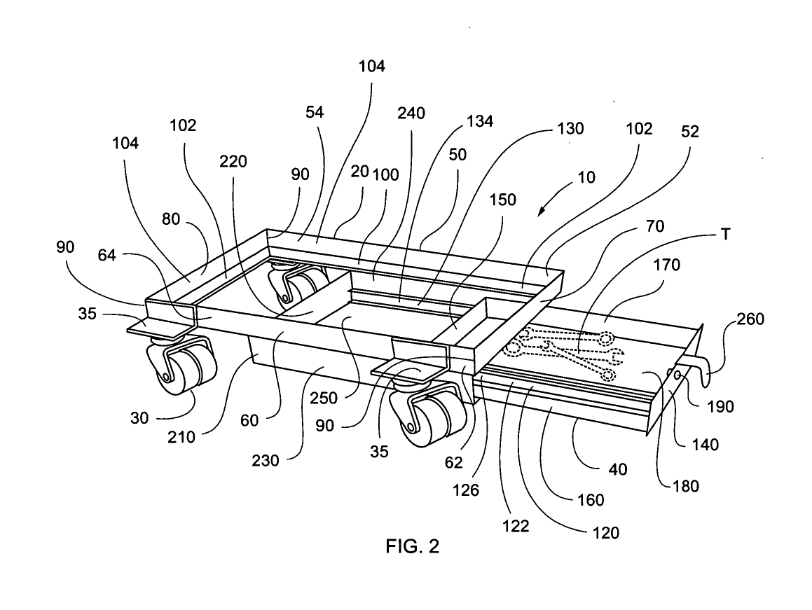

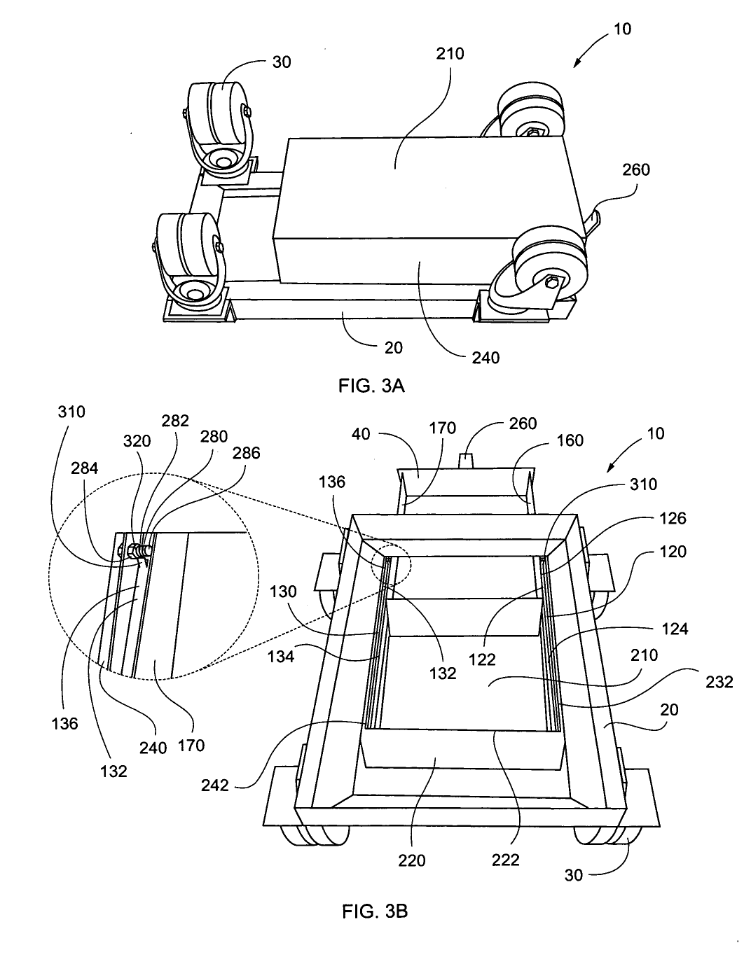

In describing the preferred and selected alternate embodiments of the present invention, as illustrated in FIGS. 1A-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-3B, the present invention in a preferred embodiment is dolly 10 comprising frame 20, wheels 30 and drawer 40, wherein frame 20 is preferably fabricated from angle iron. It will be recognized by those skilled in the art that other structural material may selectively be utilized without departing from the present invention. The angle iron of frame 20 is secured to form joints 90 via any suitable means, such as, for exemplary purposes only, welding, gluing or via a flange with bolt and nut combination. By utilizing a flange with bolt and nut combination, the size of frame 20 may be selectively adjusted to suit a variety of different sized toolboxes.

Frame 20 comprises first side 50, second side 60, first end 70 and second end 80. First side 50, second side 60, first end 70 and second end 80 are joined together via joints 90. The generally rectangular framework formed from first side 50, second side 60, first end 70 and second end 80, collectively form top support 100, wherein top support 100 comprises flat surface 102 and retaining ridges 104. Toolbox TB is preferably placed within retaining ridges 104 on flat surface 102, wherein retaining ridges 104 maintain toolbox TB on dolly 10.

Wheels 30 are supported on brackets 35, wherein brackets 35 are disposed at first end 52 and second end 54 of first side 50, and at first end 62 and second end 64 of second side 60, and wherein brackets 35 are fixably secured to sides 50 and 60 via welding, gluing, or the like.

Drawer box 210 comprises back 220, left side 230, right side 240 and bottom 250. Drawer box 210 is preferably fixably secured to frame 20 at first side 50, second side 60, and first end 70 via welding, gluing, or the like. In an alternate embodiment of the present invention, wherein frame 20 is adjustable through use of a flange with bolt and nut combination, drawer box 210 may be fixably secured to only first end 70 and one of sides 50 and 60, thereby permitting adjustment in two dimensions.

Drawer 40 preferably comprises drawer front 140, back 150, left side 160, right side 170, bottom 180, lock 190, and pull handle 260, preferably fixably secured to each other via welding, gluing, or the like.

Drawer 40 is slidably retained within drawer box 210 via left slide 120 and right slide 130. Left slide 120 and right slide 130 are disposed between drawer box 210 and drawer 40, wherein left slide 120 and right slide 130 serve to permit slidable withdrawal and replacement of drawer 40 within drawer box 210, while contemporaneously providing support to drawer 40 within dolly 10.

Left slide 120 preferably comprises outer half 122 and inner half 124, Similarly, right slide 130 preferably comprises outer half 132 and inner half 134. Outer halves 122 and 132 are fixably attached to left side 160 and right side 170, respectively, of drawer 40, wherein inner halves 124 and 134 are fixably attached to left side 230 and right side 240, respectively, of drawer box 210. Inner half 124 and outer half 122 slidably engage one another, wherein inner half 134 and outer half 132 slidably engage one another.

In order to retain drawer 40 within dolly 10, outer halves 122 and 132 of drawer slides 120 and 130, respectively, further comprise tangs 310, wherein tangs 310 are located proximate trailing ends 126 and 136 of outer halves 122 and 132, respectively. Upon slidable withdrawal of drawer 40 from drawer box 210, drawer 40 is prevented from further withdrawal by engagement of tangs 310 with pins 280. Pins 280 preferably comprise a rod-like device, wherein pins 280 extend perpendicularly from left side 230 and right side 240 inward across the top of drawer slides 120 and 130. Pins 280 comprise bolt 282 and nut 284, wherein bolts 282 are inserted through holes 320 in left side 230 and right side 240 of drawer box 210 and are secured therein via nuts 284, thereby providing extension 286 for engagement with tangs 310. As such, pins 280 serve to prevent full withdrawal or complete removal of drawer 40 from dolly 10.

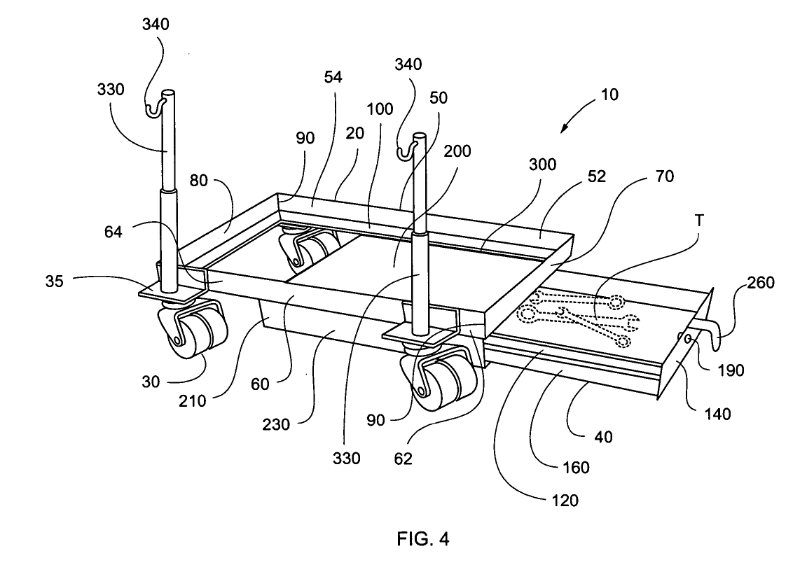

Referring now more specifically to FIG. 4, illustrated therein is an alternate embodiment of dolly 10, wherein the alternate embodiment of FIG. 4 is substantially equivalent in form and function to that of the preferred embodiment detailed and illustrated in FIGS. 1-3B except as hereinafter specifically referenced. Specifically, the embodiment of FIG. 4 comprises dolly 10 further including cover 200. Cover 200 is fixably attached to drawer box 210 via welding periphery 300 of cover 200 to top edge 222 of back 220, top edge 232 of left side 230, and to top edge 242 of right side 240 of drawer box 210. Cover 200 provides containment for tools T, while in drawer 40, while drawer 40 is closed, thereby preventing access when utilized in concert with lock 190. Further, cover 200 could function as a work surface upon removal of toolbox TB therefrom. Additionally, brackets 35 comprise risers 330 thereon, wherein risers 330 are fixably attached to brackets 35 via welding or the like. Hooks 340 are secured to risers 330 for permitting the removable support of articles thereon. It should be recognized by those in the art that risers 330 may be of any suitable height to facilitate removable support of articles of differing size thereon. It should further be recognized that hooks 340 may be replaced by clamps, clips, or other suitable retaining devices.

In yet another alternate embodiment of the present invention, risers 330 could be telescopic for selectively adjusting the height of risers 330.

In still yet another alternate embodiment of the present invention, tangs 310 could be carried by sides 160 and 170 of drawer 40.

In a further alternate embodiment of the present invention, frame 20 could be formed from any suitable structural material and comprise any shape suitable for supporting a toolbox thereon.

In yet a further alternate embodiment of the present invention, wheels 30 could be replaced by other suitable means for sliding, such as, slide rails or pads, thereby permitting dolly 10 to be moved across surfaces unsuitable for wheels.

In still another alternate embodiment of the present invention, dolly 10 could comprise a handle for pulling or pushing dolly 10 from one location to another.

In yet still another alternate embodiment of the present invention, dolly 10 could comprise multiple drawers.

In another alternate embodiment of the present invention, only one of outer halves 122 and 132 could have tang 310 located thereon and only one of left side 230 and right side 240 of drawer box 210 could have bolt 282 secured therethrough via nut 284.

In operation, toolbox TB is placed upon dolly 10, wherein toolbox TB resides within frame 20 on flat surfaces 102 and is retained within frame 20 via retaining ridges 104 thereof. Dolly 10 is subsequently moved by pushing or pulling same to a selected location, thereby transporting toolbox, TB. Tools T or other articles are selectively placed within drawer 40 or on hooks 340, thereby affording a user expeditious accessibility to tools T in lieu of having to dig through toolbox TB to locate a selected tool T, amongst a plurality of loose tools. On conclusion of work, tools T and toolbox TB are returned to a selected location.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. A dolly comprising:
a frame;
a means for transporting said frame; and
at least one drawer.

2. The dolly of claim 1, wherein said frame is adapted to receive a toolbox.

3. The dolly of claim 2, wherein said frame is adapted to removably maintain said toolbox within said frame.

4. The dolly of claim 2, wherein said frame is adapted to removably maintain said toolbox on said frame.

5. The dolly of claim 1, wherein said frame further comprises a plate adapted to function as a cover for said at least one drawer when said at least one drawer is closed.

6. The dolly of claim 1, wherein said at least one drawer further comprises a means for locking.

7. The dolly of claim 1, wherein said means for transporting comprises a means for rolling.

8. The dolly of claim 7, wherein said means for rolling comprises a plurality of wheels.

9. The dolly of claim 1, wherein said means for transporting comprises a means for sliding.

10. The dolly of claim 1, wherein said frame further includes hooks.

11. The dolly of claim 1, further comprising a means for retaining said at least one drawer.

12. The dolly of claim 11, wherein said at least one drawer comprises at least one drawer slide.

13. The dolly of claim 12, wherein said at least one drawer slide comprises at least one tang.

14. The dolly of claim 13, wherein said means for retaining comprises at least one pin and said at least one tang.

15. The dolly of claim 14, wherein said at least one pin is adapted to engage said at least one tang.

16. The dolly of claim 14, wherein said at least one pin is carried by said frame.

17. A method of transporting a toolbox, comprising the steps of:
a. obtaining a dolly comprising a frame, a plurality of wheels and at least one drawer;
b. placing the toolbox on said dolly; and
c. moving said dolly.

18. A dolly comprising:
at least one drawer; and
a frame, wherein said frame comprises supports for removably securing articles thereto.

19. The dolly of claim 18, wherein said supports comprise hooks.

20. The dolly of claim 18, wherein said supports comprise risers.
